(19) United States
(12) Patent Application Publication
(10) Pub. No.: US 2009/0311928 A1
(43) Pub. Date: Dec. 17, 2009

(54) LIFE VEST WITH TWO-WAY RADIO

(75) Inventors: Jason T. McClintock, Wichita, KS (US); Luke E. Kelly, Augusta, KS (US)

Correspondence Address: The Coleman Company, 3600 North Hydraullic, IP Legal- 11702, WICHITA, KS, 67219, US

(73) Assignee: THJE COLEMAN COMPANY, INC., Wichita, KS (US)

(21) Appl. No.: 12/301,733

(22) PCT Filed: May 1, 2007
(86) PCT No.: PCT/US07/67898

§ 371 Date: Apr. 14, 2009

Related U.S. Application Data
(60) Provisional application No. 60/747,902, filed on May 22, 2006.

(51) Int. Cl. B63C 9/20; B63C 9/08; H01R 11/00

(52) U.S. Cl. 441/89; 441/106; 439/502

(57) ABSTRACT

A life vest having a built-in two-way radio. The two-way radio may be mounted behind a protective covering. The protective covering includes contours that match buttons for the two-way radio, and depressing or otherwise actuating the contours results in actuation of the corresponding buttons or controls for the two-way radio.

### REFERENCE TO RELATED APPLICATION

This application claims priority to U.S. provisional patent application Ser. No. 60/747,902, filed May 22, 2006, and incorporated herein by reference.

### BACKGROUND OF THE INVENTION

A life vest, also known as a life jacket, is a life preserver, or personal floatation device (PFD), in the form of a buoyant vest. Life vests that are designed to be worn while water skiing or wake boarding are often referred to as “ski vests.”

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a life vest is provided having a built-in two-way radio. In an embodiment, a two-way radio is positioned adjacent a head opening of the life vest, on a shoulder of the life vest, but the two-way radio may be positioned in other locations on the life vest. A protective covering, such as a nylon covering, may be provided between the radio and a shoulder of a wearer of the life vest.

In accordance with an embodiment, the two-way radio is mounted behind a flexible protective covering. The flexible protective covering includes contours that match buttons for the two-way radio, and depressing or otherwise actuating the contours results in actuation of the corresponding buttons or controls for the two-way radio.

In accordance with an embodiment, a life vest is provided having a built-in MP3 player. In an embodiment, an MP3 player is positioned adjacent a head opening of the life vest, on a shoulder of the life vest, but the MP3 player may be positioned in other locations on the life vest.

In accordance with an embodiment, the MP3 player is mounted in a waterproof or water resistant pocket behind a protective covering. The life vest may include an extension cord that extends from the interior of the pocket to a shoulder portion of the vest so that headphones to be used with the MP3 player may be plugged into the end of the extension cord at the shoulder portion, with the other end of the extension cord plugged into the MP3 player.

Other features of the invention will become apparent from the following detailed description when taken in conjunction with the drawings, in which:

### BRIEF DESCRIPTION OF THE DRAWINGS

FIG. 1 is a side perspective view of a life vest in accordance with an embodiment;

FIG. 2 is an exploded side perspective view of the life vest of FIG. 1;

FIG. 3 is a diagrammatic view of a cross section of the life vest of FIG. 1, showing insertion of a radio into the life vest;

FIG. 4 is a front view of a life vest in accordance with an alternate embodiment;

FIG. 5 is a side perspective view of yet another life vest, in accordance with an embodiment; and

FIG. 6 is an exploded side perspective view of the life vest of FIG. 5.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order to not obscure the embodiment being described.

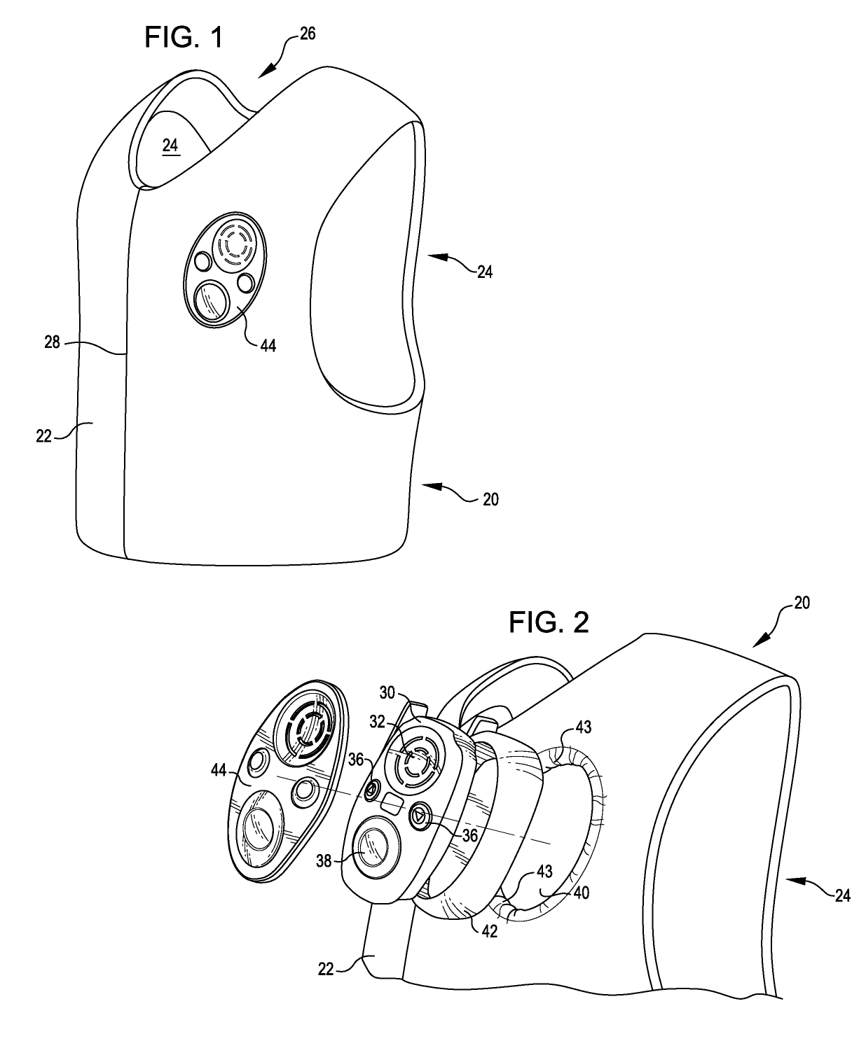

Referring now to the drawings, in which like reference numerals represent like parts throughout the several views, FIG. 1 shows a life vest 20 in accordance with an embodiment. The life vest 20 shown in the drawings includes a body section 22 for fitting around a torso of the user. Arm holes 24 and a head opening 26 are provided for fitting the life vest 20 onto a user. A fastener 28, such as a zipper, is positioned along a front of the body section 22 for allowing release and attachment of the life vest 20 to a user.

In accordance with an embodiment, the life vest 20 is provided with a built-in two-way radio 30 (FIG. 2). By “built-in,” we mean that the two-way radio 30 is removably or permanently attached to the life vest 20. In the embodiment shown in the drawings, the two-way radio 30 is removably attached to a shoulder region of the life vest 20.

As is known, a two-way radio (also known as a “transceiver”) is a radio that can both transmit and receive radio signals. The two-way radio 30 shown in the drawings includes a microphone/speaker 32, up and down volume controls 34, 36, and a talk button 38. Other controls may be provided, including a channel selection interface, a display, an on/off button, or other controls providing desired features.

In the embodiment shown in the drawings, the layout of the controls for the two-way radio 30 is particularly conducive for use in the life vest 20. Often, a user will actuate the controls while skiing, wakeboarding, or while otherwise engaged in active sports. At such times, it is not easy for a user to look at his or her shoulder to actuate one of the controls. The very large talk button 38 is conveniently located at a bottom, front side of the radio, so that the talk button is easily found and actuated by a user. This positioning of the talk button 38 and the size of the talk button 38 permit a user to very simply reach and feel for the talk button and press the button as needed, without having to view the two-way radio 30.

The volume controls 34, 36 are also located on the front side of the two-way radio 30. Once a user gets used to the controls, it is easy for that user to find the talk button 38 or the two-way radio 30, and to feel from that location to the volume controls 34, 36. Other controls may also be placed on the front of the two-way radio 30 for easy access.

In accordance with an embodiment, as shown in FIG. 2, the two-way radio 30 fits into a recess 40 in the life vest 20. In the embodiment shown in the drawing, the recess 40 includes a form fitting pocket 42 into which the two-way radio 30 is inserted. The recess 40 may have an inner edge 43 extending around at least a portion of the perimeter of the recess 40. The inner edge 43 may be made from an elastic material, such as lycra, that allows portions of the life vest 20 adjacent to the recess 40 to flex around the two-way radio 30 when the life vest 20 is in use. An outer shroud 44 fits over an outside of the two-way radio 30.

In an embodiment, the outer shroud 44 includes openings and/or contoured surfaces that match the controls and/or the microphone/speaker 32 for the two-way radio 30. In addition, the outer shroud 44 is made of a flexible material so that pushing contours on the outer shroud results in actuating the controls for the two-way radio. In this manner, the outer shroud 44 acts as a protective covering for the two-way radio 30, but yet still permits operation of the two-way radio while the two-way radio is covered. In an embodiment, the outer shroud 44 is formed of thermoplastic rubber (TPR), vulcanized rubber, or soft plastic, but other materials may be used. TPR works particularly well because it is a soft and flexible product and is usually more economical to produce than vulcanized rubber parts having similar physical characteristics.

Because the two-way radio 30 includes controls on its front, the outer shroud 44 may provide protection for the controls by extending over just a front of the two-way radio. In addition, by being contoured similar to the front of the two-way radio 30, the outer shroud 44 provides the previously-described benefit of making the controls easy to find through tactile feel without having to look at the controls.

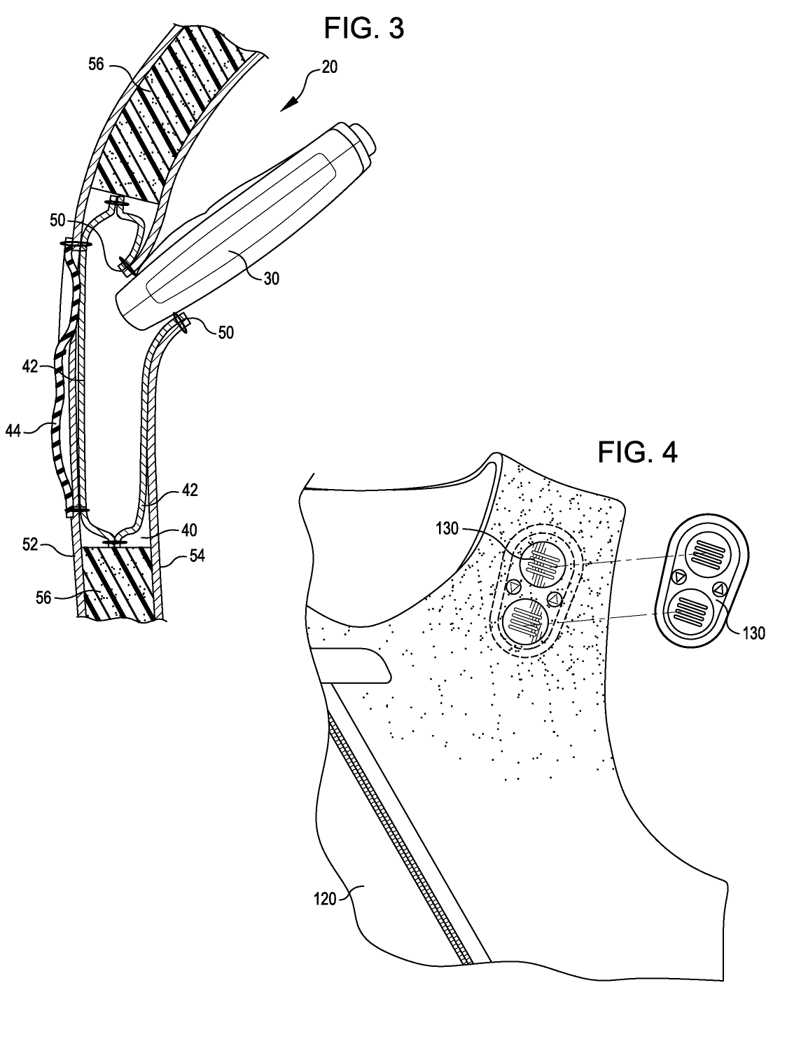

A cross section of the life vest 20 is shown in FIG. 3. As can be seen, the recess 40 includes a slit 50 at an upper rear portion that permits a user to install the two-way radio 30 from the back side. The slit 50 may be closed by a loop and hook closure, tabs, hooks, a zipper, clips, clasps, or other suitable closures. After installed, the two-way radio 30 is protected from shocks by the form fitting pocket 42, and the controls on the two-way radio 30 align with the corresponding contours on the outer shroud 44.

The form fitting pocket 42 may be, for example, formed of neoprene. Both the form fitting pocket 42 and the outer shroud 44 may be sewn to the life vest 20, for example, to an outer shell 52 and/or an inner shell 54. In an embodiment, the form fitting pocket 42 may include a clear plastic front panel 55 (FIG. 4), which provides further water and shock protection. A flotation product, such as foam 56, may be received between the outer shell 52 and the inner shell 54 at places away from the form fitting pocket 42 and the recess 40.

In an alternate embodiment, a two-way radio, such as the two-way radio 130 in FIG. 4, is installed without a shroud. As an example, as shown in an alternate life vest 120 in FIG. 4, the two-way radio 130 is received in a pouch and the controls and microphone/speaker are exposed through openings in the front of the vest.

In either event, the two-way radio 30 or 130 preferably includes a watertight housing and utilizes a waterproof microphone/speaker 32. Such two-way radios are known in the art. However, the shroud 44 and the pocket 42 provide some protection from water and help prevent shock damage to the two-way radio 30.

In use, the life vest 20 may be worn while a user is skiing, wake boarding or participating in other boating activities. The two-way radio 30 permits a skiing or wakeboarding user to communicate with people in a boat or on land, without having to shout or use hand signals. In addition, the two-way radio may be used for communication while the wearer is floating in water.

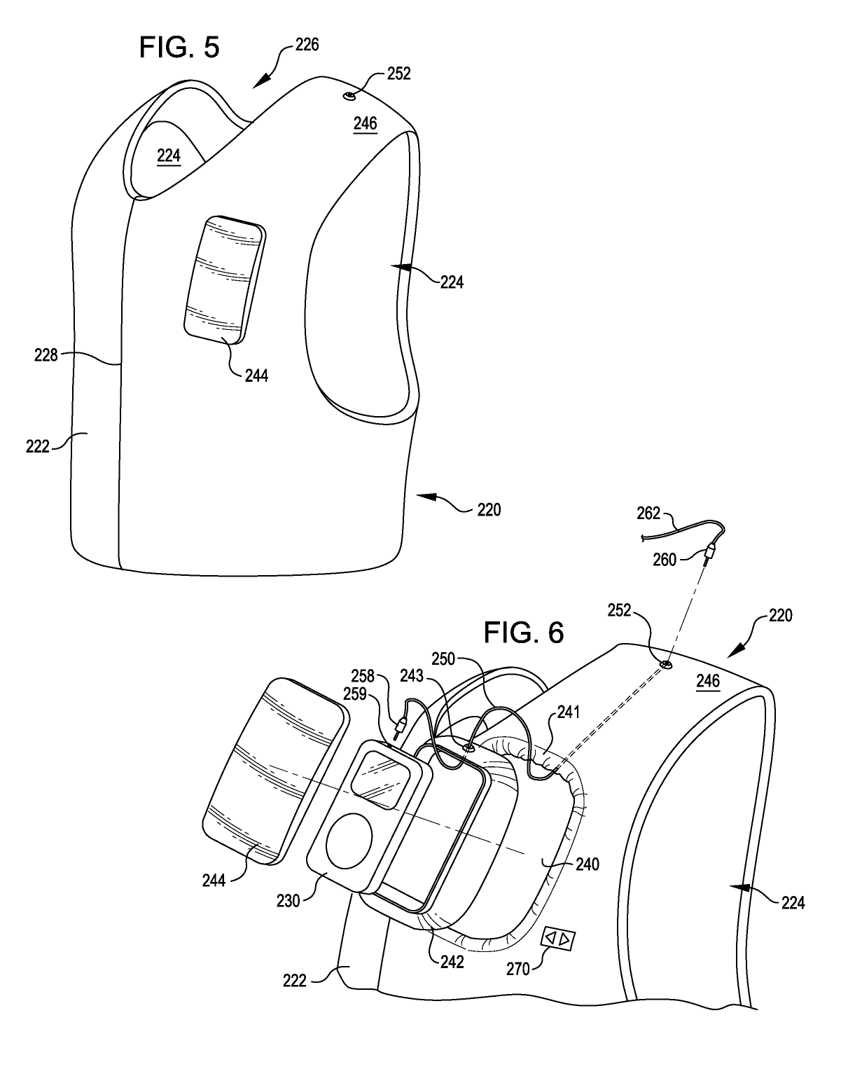

FIG. 5 shows a live vest 220 in accordance with another embodiment. The life vest 220 may be configured similar to the life vest 20. For instance, the life vest 220 may have a body section 222, armholes 224, a head opening 226, and a fastener 228.

In accordance with an embodiment, the life vest 220 is provided with a portable digital music player (e.g., an MP3 player) 230, which is a device capable of storing and playing audio and perhaps video files that are stored in a digital format, such as the well-known MP3 format. Although referred to herein as an “MP3 player” for ease of description, the digital music player may utilize any format. The MP3 player 230 may be a standalone device, or may be integrated into another device, such as a cellular telephone, Personal Digital Assistant (PDA), a radio, such as the radio 30 described above, or another device. In the embodiment shown in the drawings, the MP3 player is removably attached to a shoulder region of the life vest 220. Like the life vest 20, the life vest 220 may be attached, either removably or permanently, to other portions of the life vest 220.

In accordance with an embodiment, as shown in FIG. 6, the MP3 player 230 fits into a recess 240 in the life vest 220. Like the recess 40 of the life vest 20, the recess 240 may have an inner edge 241, configured similarly to the inner edge 43, described above. In the embodiment shown in the drawing, the recess 240 includes a pocket 242 into which the MP3 player 230 is inserted. A rubber grommet 243 extends through a side of the pocket 242, such as the top side, and an outer shroud 244 fits over an outside of the MP3 player 230.

In an embodiment, the outer shroud 244 includes openings and/or contoured surfaces that match the controls of the MP3 player 230. In addition, the outer shroud 244 may be made from the same material as the outer shroud 244.

In an embodiment, the attachment of the outer shroud 244 to the pocket 242 is waterproof, but the attachment may also be water resistant. For example, the pocket 242 may include a slot (not shown) into which a ridge (also not shown) of the outer shroud 244 tightly fits. The outer shroud 244 may also be permanently attached to the pocket 242, for example, by using glue, or forming the outer shroud 244 and the pocket 242 from a single piece of material. In this latter instance, the MP3 player 230 may be inserted from the back side, similar to the insertion of the two-way radio 30 shown in FIG. 3.

As shown in FIG. 6, the shoulder portion 246 of the life vest 230 includes an extension cord 250, which terminates in one end with a female jack 252 located on the shoulder portion 246. The female jack 252 may be configured to receive the male plug of a standard pair of headphones for listening to MP3 players, or may be configured to receive other types of plugs or other connections from earphones, such as various plugs found in earphones designed to be used with cellular telephones or PDAs. In addition, the female jack may be integrated into the material of the life vest 220.

The extension cord 250 may extend from the female jack 252, through the body of the life vest 220, through the rubber grommet 243, into the pocket 242, and terminate at a male plug 258, which is configured to plug into a headphone jack 259 of the MP3 player 230. There may be a tight fit between the extension cord 250 and the rubber grommet 243 which prevents or prohibits water entering the pocket 242 through the rubber grommet 243. Alternatively, the insulation for the extension cord 250 and the rubber grommet 243 may be formed from a single piece of material.

To use the MP3 player 230, a user simply plugs a male plug 260 of a headphone cord 262 of headphones (not shown) into the female jack 252 of the life vest 220. The extension cord 250 channels signals from the MP3 player 230 to the headphone cord 262 so that the headphone cord 250 does not need to be plugged directly into the MP3 player 230.

As shown in FIG. 6, the life vest 220 may include a volume control 270 located on a body section 222 of the life vest 220. The volume control 270 may be electrically connected to the extension cord 250 in a manner that allows a user to vary the volume of the headphones. For instance, a signal traveling from the MP3 player 230 may pass through the volume control 270 to the female jack 252 and may include a device for attenuating or amplifying that signal. Devices for controlling the volume of headphones are well known and include, for example, a device found in the KTXPRO1 Titanium Headphones manufactured by Koss. Using such a device allows a user to control the volume of his or her headphones without having to access the MP3 player, which may be more convenient while engaged in activities using the life vest 220.

While the drawings and the embodiments described above show the MP3 player 230 being connected to the female jack 252 electrically by cords, such as the cord 250, other means of integrating a female jack 252 into a life vest can be used. For instance, devices for wirelessly transmitting a signal from the MP3 player 230 to the female jack 252 may be used. Such devices may, for example, incorporate BLUETOOTH technology. In general, any mechanism for transmitting a signal from an MP3 player 230 to the female jack 252, and possibly through a volume control 270, may be used.

Although the two-way radio 30 or 130, and the MP3 player 230 are shown as being mounted on a shoulder of the vest 20, 120 or 220, the two-way radio 30 or 130, or the MP3 player 230 may be mounted at other locations on the life vest. However, by positioning it at the shoulder, the two-way radio 30, 130 or the MP3 player 230 is easily reached by a user, and, for the two-way radio 30, the microphone/speaker 32 are positioned close enough to the ear and mouth of a user that communication is possible without much amplification. Moreover, the two-way radio 30 is not submerged when the vest 20 or 120 is on a user and the user is floating in the water.

If desired, a protective layer may be provided between a user and the MP3 player 230 and/or the two-way radio 30 or 130. Such protective layer may be, for example, a nylon fabric or layer.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A life vest, comprising:
a body portion; and
a two-way radio mounted to the body portion.

2. The life vest of claim 1, further comprising a recess in the life vest configured to receive the radio.

3. The life vest of claim 2, wherein the radio comprises an outer portion, and wherein the life vest further comprises a flexible shroud configured to fit over the outer portion.

4. The life vest of claim 3, wherein the flexible shroud comprises at least one of thermoplastic rubber, vulcanized rubber, or soft plastic.

5. The life vest of claim 3, wherein the flexible shroud comprises a thermoplastic rubber.

6. The life vest of claim 3, wherein the outer portion of the radio includes at least one control, microphone, or speaker, and wherein the shroud includes at least one opening or contoured surface, the opening or contoured surface configured to match said at least one control, microphone, or speaker.

7. The life vest of claim 1, wherein the two-way radio is positioned adjacent a head opening of the life vest.

8. The life vest of claim 7, wherein the two-way radio is positioned on a shoulder of the life vest.

9. The life vest of claim 1, further comprising a protective covering, positioned so that, when a wearer is wearing the life vest, the protective covering is between the two-way radio and the wearer of the life vest.

10. The life vest of claim 9, wherein the protective covering comprises a nylon covering.

11. The life vest of claim 1, wherein the two-way radio comprises a talk button exposed to the outside of the life vest.

12. The life vest of claim 11, wherein the talk button is on the front of the two-way radio.

13. The life vest of claim 12, further comprising a volume control on the front of the two-way radio.

14. The life vest of claim 1, further comprising a form fitting pocket into which the two-way radio is fitted.

15. The life vest of claim 14, further comprising a recess in the body portion, and wherein the form fitting pocket fits into the recess.

16. The life vest of claim 14, wherein the form fitting pocket includes a clear front panel.

17. A life vest, comprising:
a body portion; and
a digital music player mounted to the body portion.

18. The life vest of claim 17, further comprising a recess in the life vest configured to receive the digital music player.

19. The life vest of claim 18, wherein the digital music player comprises an outer portion, and wherein the life vest further comprises a flexible shroud configured to fit over the outer portion.

20. The life vest of claim 19, wherein the flexible shroud comprises at least one of thermoplastic rubber, vulcanized rubber, or soft plastic.

21. The life vest of claim 19, wherein the flexible shroud comprises a thermoplastic rubber.

22. The life vest of claim 19, wherein the outer portion of the digital music player includes at least one control, and wherein the shroud includes at least one contoured surface, said at least one contoured surface configured to match said at least one control.

23. The life vest of claim 17, wherein the digital music player is positioned adjacent a head opening of the life vest.

24. The life vest of claim 23, wherein the digital music player is positioned on a shoulder of the life vest.

25. The life vest of claim 17, further comprising a protective covering, positioned so that, when a wearer is wearing the life vest, the protective covering is between the digital music player and the wearer of the life vest.

26. The life vest of claim 25, wherein the protective covering comprises a nylon covering.

27. The life vest of claim 17, wherein the digital music player is mounted in a waterproof or water resistant pocket.

28. The life vest of claim 27, wherein the pocket is mounted behind a protective covering.

29. The life vest of claim 27, further comprising an extension cord that extends from an interior of the pocket to a shoulder portion of the life vest.

30. The life vest of claim 29, wherein the extension cord comprises a female jack at the shoulder portion for attaching to a headphone jack.
